(19) United States
(12) Patent Application Publication
(10) Pub. No.: US 2026/0106547 A1
(43) Pub. Date: Apr. 16, 2026

(54) Ultra-Low Power Buck Converter and Operation Method Thereof

(71) Applicant: RICHTEK TECHNOLOGY CORP., Hsinchu County (TW)

(72) Inventors: Yu-Hsuan Liu, New Taipei City (TW); Yung-Chun Chuang, Taipei City (TW)

(21) Appl. No.: 18/914,275

(22) Filed: Oct. 14, 2024

(51) Int. Cl. H02M 3/158; H02M 1/00; H02M 1/32

(52) U.S. Cl. CPC H02M 3/158; H02M 1/0009; H02M 1/0032; H02M 1/32

(57) ABSTRACT

A buck converter includes a power stage, a feedback network coupled to the power stage, a control loop, a logic circuit coupled to the control loop, a driver circuit coupled between the logic circuit and the power stage, and a bypass detector. The feedback network is used to generate a feedback voltage according to the output voltage. The control loop includes an error amplifier (EA) for generating an EA voltage and a comparator (CMP) for generating a CMP signal. The logic circuit is used to generate a logic control signal for implementing a control scheme according to a set of control signals. The driver circuit is used to drive the power stage according to the logic control signal. The bypass detector is used to compare the input voltage with a predetermined threshold related to the output voltage and generate a bypass mode signal accordingly.

### BACKGROUND OF THE INVENTION

### 1. Field of the Invention

The present invention relates to power management in electronic systems. More specifically, it pertains to voltage regulation circuits and methods, with a particular focus on buck converters designed for ultra-low power applications.

### 2. Description of the Prior Art

Buck converters play a crucial role in modern electronics, particularly in battery-powered devices where efficient voltage regulation is paramount. These converters are tasked with stepping down voltage levels while maintaining high efficiency across a wide range of input and output conditions. As the demand for longer battery life and improved power efficiency continues to grow, the pressure on buck converter design to minimize power consumption has intensified.

Traditional buck converters face a significant challenge when the input voltage approaches or falls below the desired output voltage. To address this limitation, many designs incorporate a bypass mode, also known as 100% duty cycle mode. This mode allows the converter to maintain regulation even when the input voltage is close to or lower than the target output voltage, thereby extending the useful operating range of the device.

In typical implementations, a dedicated bypass detector continuously monitors the difference between input and output voltages. When this difference falls below a preset threshold, the bypass mode is activated, keeping the high-side power MOSFET (Metal Oxide Semiconductor Field Effect Transistor) in an on state. This effectively connects the input directly to the output, allowing the converter to operate in conditions where normal buck conversion would not be possible. The bypass mode usually remains active until the input-output voltage difference exceeds the preset threshold or until a protection circuit, such as over-current protection (OCP), is triggered.

While these existing buck converters with bypass mode offer improved versatility, they suffer from several significant limitations. One of the primary issues is the high quiescent current consumed by the bypass detector, which needs to continually monitor voltage differences. This constant power draw is particularly problematic for low-power applications, especially those relying on battery power, where every microamp of current consumption can impact overall battery life.

Another limitation lies in the inefficiency of traditional protection mechanisms. Over-current protection circuits, which are crucial for safe operation, often have high current consumption. This characteristic directly conflicts with the goal of achieving ultra-low quiescent current (IQ) in modern designs. Furthermore, many existing designs fail to optimize power consumption during bypass mode operation, missing valuable opportunities to further reduce quiescent current when the converter is not actively switching.

Additionally, some designs struggle with smooth transitions between normal operation and bypass mode. These transitional irregularities can potentially cause output voltage fluctuations, compromising the stability and reliability of the power supply.

Given these limitations, there is a clear and pressing need for an improved buck converter design. Such a design should minimize quiescent current consumption, especially during bypass mode operation, to extend battery life in portable devices. It should implement more efficient protection mechanisms that don't compromise low-power operation, ensuring safety without sacrificing efficiency. The ideal design would provide smooth transitions between operating modes, maintaining stable output voltage under all conditions. Finally, it should maintain high efficiency across a wide range of input and output voltage conditions, maximizing its versatility and applicability.

Addressing these challenges would result in a buck converter more suitable for modern, battery-powered devices where power efficiency is critical. Such an improved design would represent a significant advance in power management technology, enabling the next generation of long-lasting, efficient electronic devices.

### SUMMARY OF THE INVENTION

An embodiment provides a buck converter including a power stage, a feedback network coupled to the power stage, a control loop, a logic circuit coupled to the control loop, a driver circuit coupled between the logic circuit and the power stage, and a bypass detector. The power stage includes an input terminal for receiving an input voltage and an output terminal for outputting an output voltage. The feedback is used to generate a feedback voltage according to the output voltage. The control loop includes an error amplifier (EA) and a comparator (CMP) coupled to the error amplifier. The error amplifier is used to generate an EA voltage by comparing a reference voltage to the feedback voltage. The comparator is used to generate a CMP signal according to the EA voltage. The logic circuit is used to generate a logic control signal for implementing a control scheme according to a set of control signals. The driver circuit is used to drive the power stage according to the logic control signal. The bypass detector is used to compare the input voltage with a predetermined threshold related to the output voltage and generate a bypass mode signal accordingly.

An embodiment provides a method of operating a buck converter. The method includes operating the buck converter in a normal mode. The normal mode includes alternating activation of a high-side switch and a low-side switch to regulate an output voltage. The method further includes monitoring, by a zero current detector, a current through an output inductor of the buck converter, generating, by the zero current detector, a bypass enabling signal when the current through the inductor reaches substantially zero, enabling a bypass detector according to the bypass enabling signal, comparing, by a bypass detector, an input voltage of the buck converter to a predetermined threshold related to the output voltage, generating, by the bypass detector, a bypass mode signal when the input voltage falls below the predetermined threshold, and transitioning the buck converter from the normal mode to a bypass mode according to the bypass mode signal. The bypass mode includes the high-side switch being enabled and the low-side switch being disabled.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a buck converter with several key components according to the embodiments.

FIG. 2 is a flowchart depicting a method for operation of the buck converter of FIG. 1 transitioning to the bypass mode.

FIG. 3A and FIG. 3B are flowcharts depicting methods for operation of the buck converter of FIG. 1 in the bypass mode.

FIG. 4 is a flowchart depicting a method for operation of the buck converter of FIG. 1 in the sleep mode.

FIG. 5 is a timing diagram depicting the transition from CCM mode to bypass mode in the buck converter of FIG. 1.

FIG. 6 is a timing diagram depicting the transition from DCM mode to bypass mode in the buck converter of FIG. 1.

FIG. 7 is a timing diagram depicting the transition from bypass mode to back CCM mode with a large current event in the buck converter of FIG. 1.

FIG. 8 is a timing diagram depicting the transition from bypass mode to back CCM mode with an over current event in the buck converter of FIG. 1.

### DETAILED DESCRIPTION

The present disclosure provides a detailed description of various embodiments. While specific implementation details are presented herein to facilitate a comprehensive understanding of the disclosure, it will be apparent to those skilled in the art that the present invention may be realized without necessarily adhering to all such particularities. In certain instances, well-established methods, procedures, components, and circuits have been omitted from exhaustive description to avoid unnecessarily obfuscating the present disclosure. It should be understood that technical features individually described in relation to a single drawing may be implemented either discretely or in combination with other features, as set forth in the present specification.

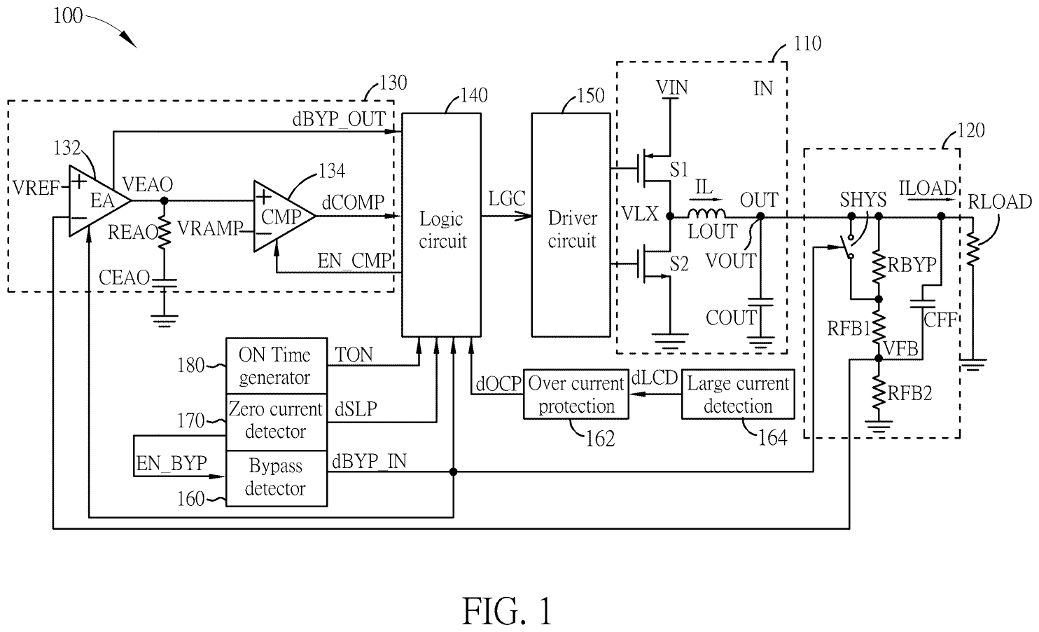

FIG. 1 depicts a buck converter 100 with several key components according to the embodiments. Specifically, the buck converter 100 includes a power stage 110, a feedback network 120 coupled to the power stage 110, a control loop 130, a logic circuit 140 coupled to the control loop 130, a driver circuit 150 coupled between the logic circuit 140 and the power stage 110, and a bypass detector 160. The buck converter 100 may further incorporate additional components, including a zero current detector 170 and an on-time generator 180, both operatively coupled to the logic circuit 140.

The power stage 110 includes an input terminal IN for receiving an input voltage VIN, and an output terminal OUT for outputting an output voltage VOUT. The feedback network 120 generates a feedback voltage VFB based on the output voltage VOUT. The control loop 130 includes an error amplifier (EA) 132 and a comparator (CMP) 134. The error amplifier 132 generates an EA voltage VEAO by comparing a reference voltage VREF to the feedback voltage VFB, while the comparator 134 produces a CMP signal dCOMP according to the EA voltage VEAO.

The power stage 110 further includes a first switch S1 (high-side switch) and a second switch S2 (low-side switch) coupled in series forming a half bridge configuration between the input terminal IN and the ground. An output inductor LOUT can be coupled between a switching node of the first switch S1 and the second switch S2 and the output terminal OUT. An output capacitor COUT can be coupled between the output terminal OUT and the ground. Furthermore, the first switch S1 can include a first terminal coupled to the input terminal IN, a second terminal coupled to the switching node, and a control terminal coupled to the driver circuit 150. Similarly, the second switch S2 can include a first terminal coupled to the switching node a second terminal coupled to the ground, and a control terminal coupled to the driver circuit 150.

The logic circuit 140 is central to the converter's operation, generating a logic control signal LGC to implement the control scheme based on various control signals. The driver circuit 150 then drives the power stage 110 according to this logic control signal LGC. The bypass detector 160 provides control signals dBYP_IN to the logic circuit 140 for transitioning to the bypass mode (which will be explained in the later paragraphs). Additionally, the zero current detector 170 generates a sleep mode signal dSLP associated with sleep mode activation, while the on-time generator 180 produces a signal TON to control the duration of each switching cycle.

The bypass detector 160 is a specialized component designed to determine when the buck converter 100 should enter bypass mode, allowing for efficient operation when the input voltage VIN is close to the desired output voltage VOUT. It can compare the input voltage VIN to a reference voltage related to the output voltage VOUT. When the input voltage VIN falls below the threshold, it generates a bypass mode signal dBYP_IN to initiate the transition to bypass mode.

In more detail, the bypass detector 160 functions to monitor the relationship between the input voltage VIN and a reference voltage. The reference voltage can be either the actual output voltage of the buck converter or a predetermined threshold voltage. The bypass detector 160 continuously compares these voltages, watching for the moment when the input voltage becomes equal to or lower than the reference voltage. When this condition is met, it can trigger the buck converter 100 to transition into bypass mode by generating the bypass mode signal dBYP_IN. This mechanism allows the buck converter 100 to adapt seamlessly to varying input conditions, particularly when the input voltage VIN approaches or falls below the desired output voltage VOUT.

The zero current detector 170 is a component designed to identify when an output current IL (flow through the output inductor LOUT) reaches zero. When the output current IL reaches substantially zero, it produces the sleep mode signal dSLP indicating the zero current condition.

The on-time generator 180 can continuously monitor the input voltage VIN and the output voltage VOUT and calculate the required on-time for the first switch S1 to maintain the desired output voltage. This calculation typically involves the equation:

$$Ton = ( VOUT \times Ts ) / VIN$$

where Ts is the switching period.

It can also adjust the on-time dynamically in response to changes in input voltage VIN or load conditions to maintain a constant output voltage VOUT.

Furthermore, the logic circuit 140 incorporates inputs from multiple protection mechanisms. It receives the OCP signal dOCP from the over-current protection circuit 162. This over-current protection circuit, in turn, can be controlled by the large current signal dLCD, which is sent from the large current detection circuit 164.

The over-current protection circuit 162 is a critical safety feature that prevents damage from excessive current draw. The over-current protection circuit 162 monitors the output current of the buck converter, typically using a sense resistor or power MOSFETs. The sensed current is compared to a predefined over-current threshold. If the threshold is exceeded, the OCP block initiates protective measures, such as turning off the first switch S1 or transitioning the buck converter 100 to the normal mode of operation (i.e., alternating activation of the first switch S1 and a the second switch S2 to regulate the output voltage Vout). It should be noted that the over-current protection circuit 162 is designed to be disabled during the bypass mode operation to save power, and is re-enabled when activated by the large current detection circuit 164.

The large current detection circuit 164 is a component designed to monitor for potentially large current during bypass mode operation while maintaining ultra-low quiescent current consumption. The large current detection circuit 164 remains active during bypass mode when the over-current protection (OCP) circuit 162 is disabled to save power. It monitors the voltage difference between the input voltage VIN and the switching node voltage VLX. This difference is proportional to the current flowing through the first switch S1. The measured voltage difference is compared to a preset threshold. This threshold is set to detect currents that are large enough to be potentially problematic but not necessarily at the full over-current level. When the threshold is exceeded, the block generates a large current signal dLCD to the over-current protection circuit 162.

The feedback network 120 is designed with a hysteresis switch SHYS and a bypass resistor RBYP, both coupled to the output terminal. A resistive divider can be coupled between the bypass resistor RBYP and the ground. The feedback network 120 can also incorporates a feed forward capacitor CFF coupled to the output terminal OUT, the resistive divider, and the error amplifier 132. The resistive divider may include two resistors RFB1 and RFB2, connected in series. The feedback voltage VFB is sensed at the junction between these two resistors RFB1 and RFB2.

The control loop 130 incorporates additional components to enhance its functionality and enable the control scheme. A resistor-capacitor (RC) circuit can be coupled between the error amplifier 132 and the ground, providing necessary compensation and stability. The RC circuit can be formed by a resistor REAO and a capacitor CEAO coupled in series.

The error amplifier 132 can be configured with a non-inverting terminal that receives the reference voltage VREF, an inverting terminal coupled to the feedback network 120, a first output terminal outputting the EA voltage VEAO, and a second output terminal coupled to the logic circuit 140.

The comparator 134 is designed with a non-inverting terminal connected to the first output terminal of the error amplifier 132, an inverting terminal receiving a voltage VRAMP, an output terminal coupled to the logic circuit 140, and a signal terminal coupled to the logic circuit 140. This arrangement enables the comparator 134 to generate the CMP signal dCOMP while allowing the logic circuit 140 to control its power state. It should be noted that signal EN_CMP is used to control the activation state of the comparator 134.

The load RLOAD represents an electrical load connected to the output terminal OUT of the buck converter 100, which draws a load current ILOAD. The magnitude of the load current ILOAD is a critical parameter that determines the operating mode of the converter within the control scheme.

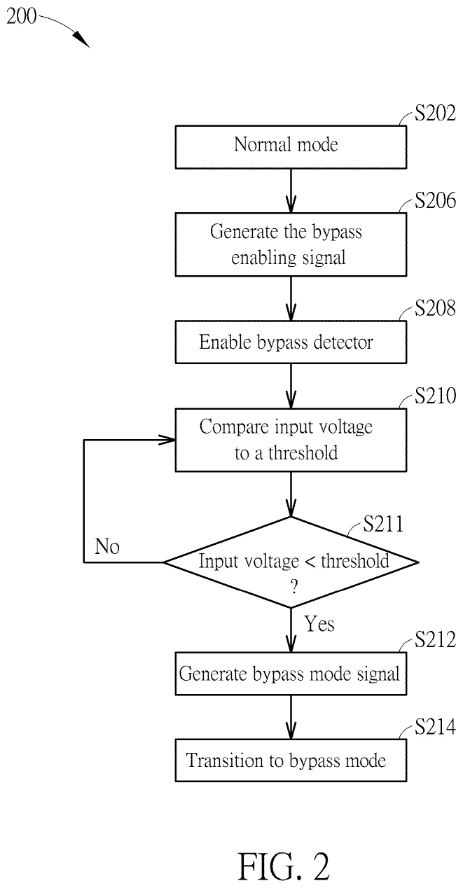

FIG. 2 is a flowchart depicting a method 200 for operation of the buck converter 100 transitioning to the bypass mode. The bypass mode, also known as 100% duty cycle mode, is an operating state in buck converters of the embodiments designed to handle situations where the input voltage VIN approaches or falls below the desired output voltage VOUT. This mode extends the converter's operational range and improves efficiency under these specific conditions. The method 200 includes the following steps:
S202: Operate the buck converter 100 in a normal mode;
S206: Generate the bypass enabling signal EN BYP;
S208: Enable the bypass detector 160;
S210: Compare the input voltage VIN to a predetermined threshold related to the output voltage VOUT by a bypass detector 160 of the buck converter;
S211: Does the input voltage fall below the predetermined threshold? If so, proceed to S212; if not, go back to S210;
S212: Generate a bypass mode signal dBYP_IN;
S214: Transition the buck converter 100 from the normal mode to the bypass mode.

In the bypass mode, the bypass detector 160, over-current protection circuit 162, and comparator 134 are disabled to reduce power consumption. However, the large current detection circuit 164 is enabled for the above described function. Furthermore, the first switch S1 is enabled while second switch S2 and hysteresis SHYS are disabled in bypass mode.

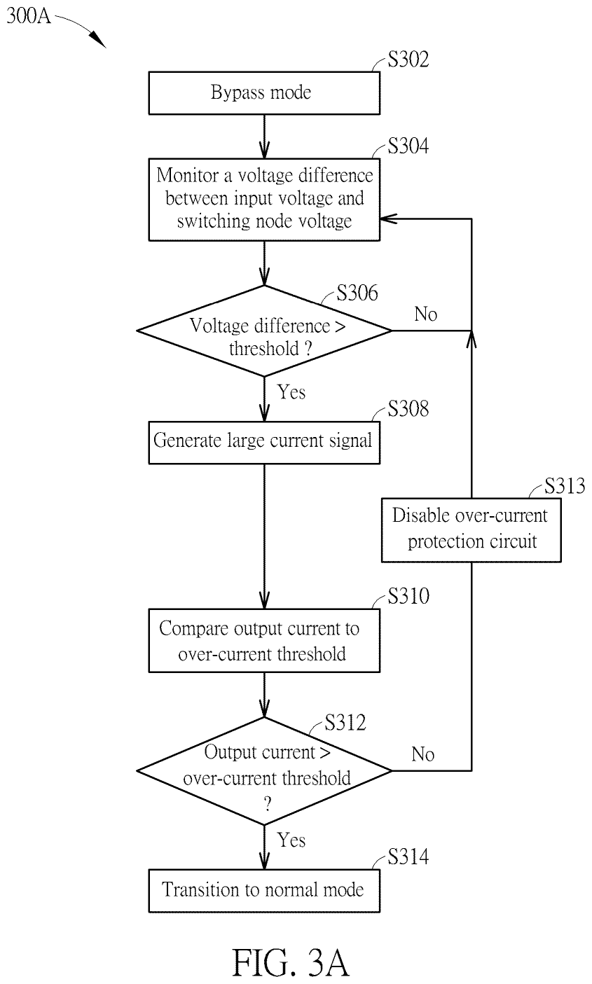

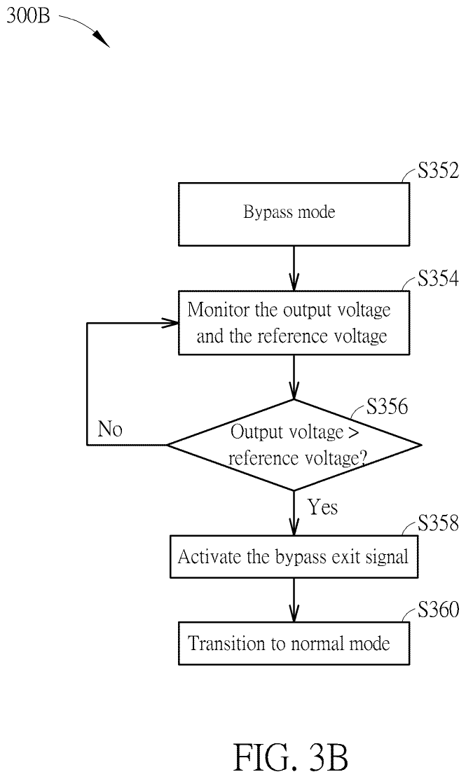

FIG. 3A is a flowchart depicting a method 300A for operation of the buck converter 100 in the bypass mode. The method 300A includes the following steps:
S302: While operating in the bypass mode, disable the over-current protection circuit 162 and enable the large current detection circuit 164;
S304: Monitor the voltage difference between the input voltage VIN and a switching node voltage VLX by the large current detection circuit 164;
S306: Does the voltage difference exceed a predetermined threshold? If so, proceed to S308; if not, go back to S304;
S308: Generate the large current signal dLCD by the large current detection circuit 164 to enable the over-current protection circuit 162;
S310: Compare the output current IL to an over-current threshold by the over-current protection circuit 162;
S312: Does the output current IL exceed an over-current threshold? If so, proceed to S314; if not, proceed to S313;
S313: Disable the over-current protection circuit 162; go back to S304;
S314: Transition the buck converter 100 from the bypass mode to the normal mode.

During bypass mode operation, the buck converter 100 employs a large current detection mechanism instead of traditional over-current protection (OCP) to monitor output current variations. This approach significantly reduces power consumption while maintaining essential protection features.

The large current detection circuit 164 operates by continuously monitoring the voltage difference between the input voltage (VIN) and the switching node voltage VLX, which is the connection point between the first switch S1 and the second switch S2. This voltage difference is directly proportional to the output current, following the relationship:

$$VIN - VLX = IL \times RS 1$$

Where RS1 is the on-resistance of the first switch S1.

The circuit compares this voltage difference against a preset threshold. If the difference exceeds this threshold, it indicates a large current event is occurring. This could be due to a sudden increase in load demand or a potential fault condition.

Upon detecting a large current event, the circuit triggers a wake-up signal to activate the full over-current protection (OCP) system. This staged approach allows the converter to maintain ultra-low quiescent current during bypass mode operation while still providing robust protection when needed.

This large current detection mechanism exemplifies the buck converter's design of balancing ultra-low power consumption with comprehensive protection features.

FIG. 3B is a flowchart depicting a method 300B for operation of the buck converter 100 in the bypass mode. The method 300 includes the following steps:
S352: While operating in the bypass mode, disable the over-current protection circuit 162 and enable the large current detection circuit 164;
S354: Monitor the output voltage VOUT and the reference voltage VREF;
S356: Does the output voltage VOUT exceed the reference voltage VREF? If so, proceed to S358; if not, go back to S354;
S358: Activate the bypass exit signal dBYP_OUT; and
S360: Transition the buck converter 100 from the bypass mode to the normal mode.

The above steps demonstrate an alternative sequence for managing bypass mode operation and exit. The design allows for smooth transitions between modes, enhancing overall system stability. The continuous monitoring and conditional exit ensure the converter operates in the most appropriate mode for the current conditions. Thus, this method effectively balances the need for power efficiency in bypass mode with the requirement for proper voltage regulation and protection, making it well-suited for battery-powered applications where both factors are critical.

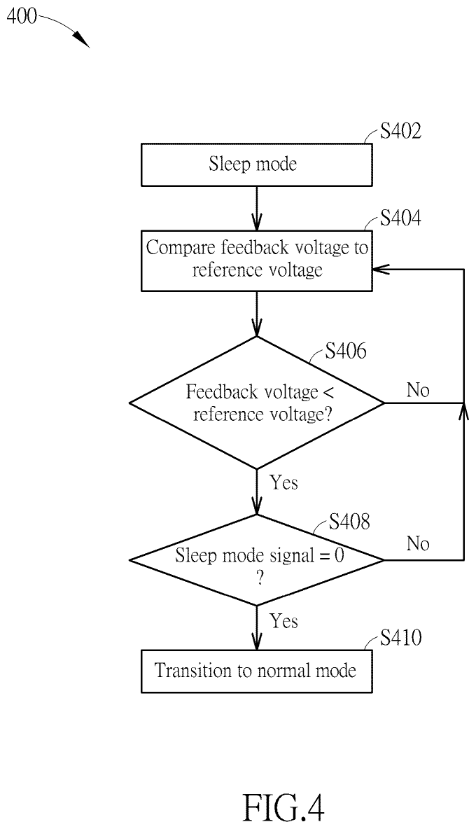

FIG. 4 is a flowchart depicting a method 400 for operation of the buck converter 100 in the sleep mode. The method 400 includes the following steps:
S402: While operating in the sleep mode, disabling the over-current protection circuit 162, the bypass detector 160 and comparator 134;
S404: Compare the feedback voltage VFB to the reference voltage VREF by the error amplifier 132;
S406: Does the feedback voltage VFB fall below the reference voltage VREF? If so, proceed to S408; if not go back to S404;
S408: Is the sleep mode signal at a low level? If so, proceed to S410; if not go back to S404;
S410: Transition the buck converter 100 from the sleep mode to the normal mode.

It should be noted that the buck converter 100 operates in two primary modes: continuous conduction mode (CCM) and discontinuous conduction mode (DCM). In CCM, the output current IL typically would not fall to zero during the switching cycle. This mode is often observed under moderate to heavy load conditions. The inductor current waveform in CCM resembles a triangular wave with a DC offset, oscillating above zero. CCM offers several advantages, including lower peak currents, which reduces conduction losses and electromagnetic interference (EMI). It also provides better voltage regulation and faster transient response due to the energy constantly stored in the inductor. However, CCM can suffer from higher switching losses, especially at light loads, due to the continuous switching of the MOSFETs.

Discontinuous conduction mode (DCM), on the other hand, occurs when the inductor current falls to zero for a portion of each switching cycle. This mode is commonly encountered under light load conditions or when the converter is designed with a relatively small inductance. In DCM, the inductor current waveform can include a series of triangular pulses that start from zero, rise to a peak, and then fall back to zero, remaining at zero for some time before the next cycle begins. This period of zero current is commonly known as sleep mode. DCM offers improved efficiency at light loads by reducing switching losses, as the low-side MOSFET can be turned on at zero current, eliminating turn-on losses. It also allows for the use of smaller inductors, which can be beneficial for miniaturization. However, DCM typically results in higher peak currents and increased output voltage ripple compared to CCM.

The transition between CCM and DCM is dynamic and depends on the load current, input voltage, and converter design parameters. Modern buck converters, including this ultra-low IQ design, often implement sophisticated control schemes to seamlessly transition between these modes, optimizing efficiency across a wide range of operating conditions. The zero current detector 170 has an important role in identifying the transition point between CCM and DCM, allowing the controller to adapt its switching strategy accordingly. In light load conditions, the converter may intentionally operate in DCM to improve efficiency, while at higher loads, it switches to CCM for better regulation and lower conduction losses. This adaptive approach, combined with the bypass mode for very light loads or when input voltage approaches output voltage, enables the buck converter to maintain high efficiency across its entire operating range, making it particularly well-suited for battery-powered applications where power conservation is important.

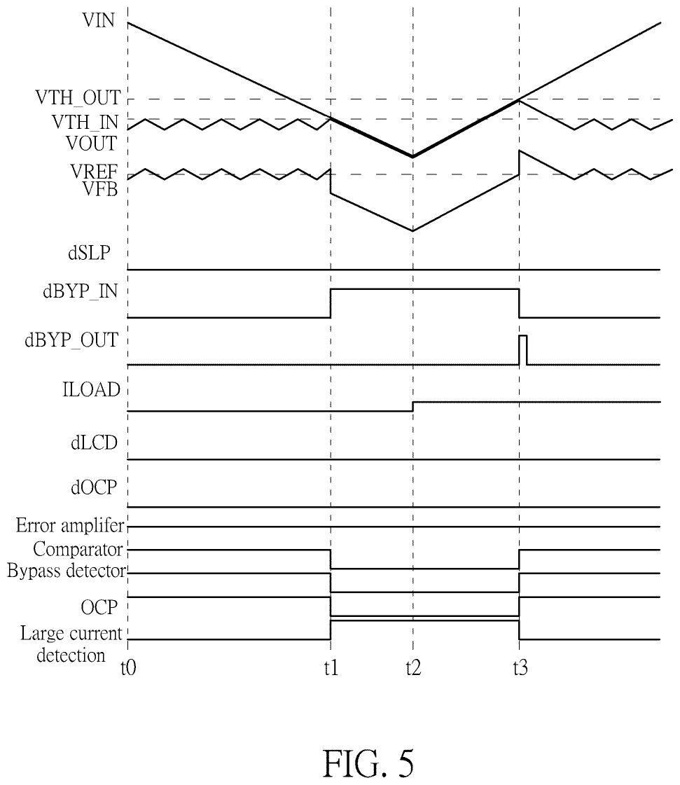

FIG. 5 is a timing diagram depicting the transition from CCM mode to bypass mode in the buck converter 100. Between time t0 and t1, the buck converter 100 is operating in CCM mode. The input voltage VIN is higher than the output voltage VOUT but starts dropping. The feedback voltage VFB is oscillating around the reference voltage VREF, indicating normal regulation. The error amplifier 132, comparator 134, bypass detector 170, and over-current protection circuit 162 are all active. The large current detection circuit 164 is disabled.

At time t1, the input voltage VIN drops to reach a voltage threshold VTH_IN, which initiates the transition into bypass mode. The bypass mode signal dBYP_IN goes high, causing the buck converter 100 to enter into the bypass mode. The bypass detector 170, comparator 134 and over-current protection circuit 162 are disabled to reduce power consumption. The large current detection circuit 164 is enabled for its function.

Between time t1 and t2, the buck converter 100 enters bypass mode. The output voltage VOUT closely follows input voltage VIN as both continue to drop. The feedback voltage VFB drops below the reference voltage VREF, as the hysteresis switch SHYS turns off causing a hysteresis effect. Also, precise voltage regulation is no longer maintained. The error amplifier 132 remains on to monitor the output voltage VOUT.

At time t2, the input voltage VIN reaches its lowest point and begins to rise again. The load current ILOAD increases, as indicated by the rising line. Between time t2 and t3, the input voltage VIN continues to rise. The other signals remain the same.

At time t3, the buck converter 100 initiates its transition out of bypass mode as the output voltage VOUT reaches the predefined voltage threshold VTH_OUT. This transition is set by the error amplifier 132, which generates a pulse signal dBYP_OUT to indicate the end of bypass mode. At the same time, the buck converter 100 reactivates the bypass detector 170, comparator 134, and over-current protection circuit 162. Conversely, the large current detection circuit 164, which was active during bypass mode, is now disabled. These coordinated actions prepare the buck converter 100 to resume CCM operation. Following t3, the converter fully returns to CCM, operating with its normal switching behavior.

It is important to note that the buck converter 100 can exit bypass mode by using the error amplifier 132 as a key component in this process. During bypass mode operation, the output voltage VOUT closely tracks the input voltage, effectively connecting the input IN directly to the output OUT through the first switch S1. Throughout the bypass mode, the error amplifier 132 remains active, continuously monitoring the relationship between the feedback voltage VFB and a reference voltage VREF.

The reference voltage VREF serves as a benchmark, representing either the ideal regulated output voltage or a predetermined threshold voltage set by the designer. The error amplifier 132 precisely measures the difference between the actual output voltage and this reference voltage. This continuous comparison allows the system to detect when conditions become favorable for resuming normal buck converter operation.

In some embodiments, the exit from bypass mode may be triggered when the error amplifier 132 detects that the output voltage VOUT has become equal to or has risen above the reference voltage VREF. This condition typically occurs when the input voltage VIN increases sufficiently to allow for proper voltage step-down operation. Upon detecting this voltage relationship, the error amplifier 132 generates a signal dBYP_OUT to initiate the transition out of bypass mode.

The disclosed procedure has several advantages. Firstly it provides a smooth Transition. By using the error amplifier 132, which is already a core component of the control loop, a smooth transition back to normal operation can be achieved without introducing additional switching or potential instabilities. Secondly, it gives precise control. The use of a reference voltage allows for precise control over when the converter exits bypass mode, ensuring that it happens at the optimal point for maintaining output voltage regulation. Third, it offers flexibility. The reference voltage VREF can be adjusted based on system requirements, allowing designers to fine-tune the bypass mode exit point for different applications or operating conditions. Furthermore, it includes energy efficiency. This procedure does not require additional high-power components to be active during bypass mode, maintaining the ultra-low quiescent current characteristic of the design. Finally, the procedure introduces adaptive operation. The system can dynamically respond to changing input voltage conditions, seamlessly transitioning between modes to maintain optimal efficiency and regulation.

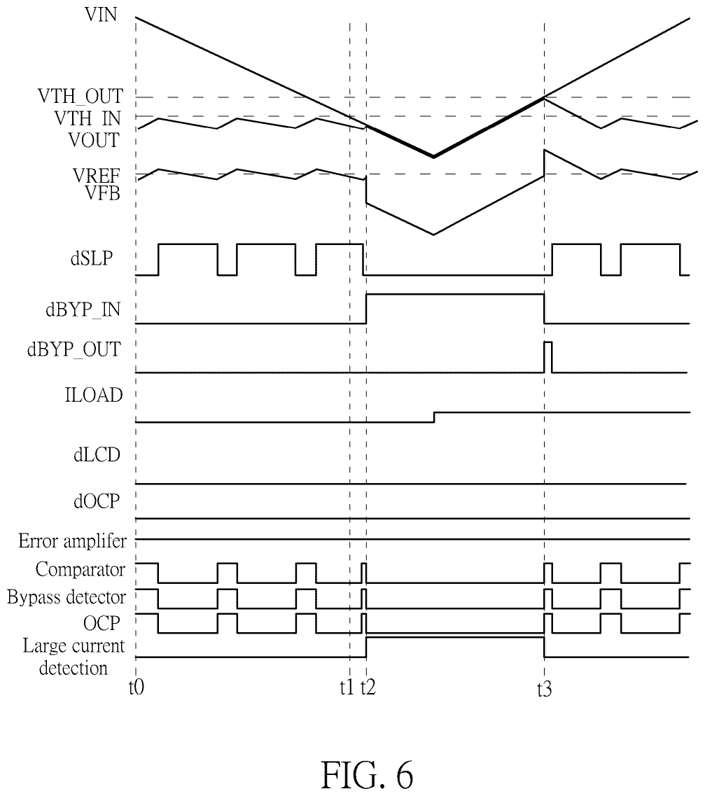

FIG. 6 is a timing diagram depicting the transition from DCM mode to bypass mode in the buck converter 100. Between time t0 and t1, the buck converter 100 is operating in DCM. The input voltage VIN decreases but still above the output voltage VOUT. The feedback voltage VFB is oscillating around the reference voltage VREF. During the normal mode, the error amplifier 132, comparator 134, bypass detector 170, and over-current protection circuit 162 are all active. In sleep mode, all these components are inactive except for the error amplifier 132, which remains active. The large current detection circuit 164 is disabled.

At time t1, the input voltage VIN drops to reach a voltage threshold VTH_IN, which initiates the transition to bypass mode. However, the buck converter 100 is operating in the sleep mode during this time. It needs to wake up from sleep mode and then transition to bypass mode.

Between time t1 and t2, the comparator 134, bypass detector 160 and over-current protection 162 are all activated, indicating the buck converter 100 waking up from sleep mode. The input voltage VIN continues to decrease, approaching the output voltage VOUT.

At time t2, the bypass mode signal dBYP_IN goes high, causing the buck converter 100 to enter the bypass mode. The comparator 134, bypass detector 160 and over-current protection circuit 162 are all deactivated while the large current detection circuit 164 is activated.

Between time t2 and t3, the buck converter 100 remains in bypass mode. The input voltage VIN reaches its lowest point and begins to rise again. The output voltage VOUT closely follows the input voltage VIN. The large current detection circuit 164 is active, indicating active monitoring during bypass mode.

At time t3, the output voltage VOUT has increased to reach a threshold voltage threshold VTH_OUT, which trigger the buck converter 100 to exit the bypass mode. The error amplifier 132 generates a pulse signal dBYP_OUT, signaling the end of bypass mode. The bypass detector 170, comparator 134, and over-current protection circuit 162 are reactivated. The large current detection 164 is disabled. This reconfiguration prepares the buck converter 100 to resume DCM operation. Following time t3, the buck converter 100 fully returns to DCM operation.

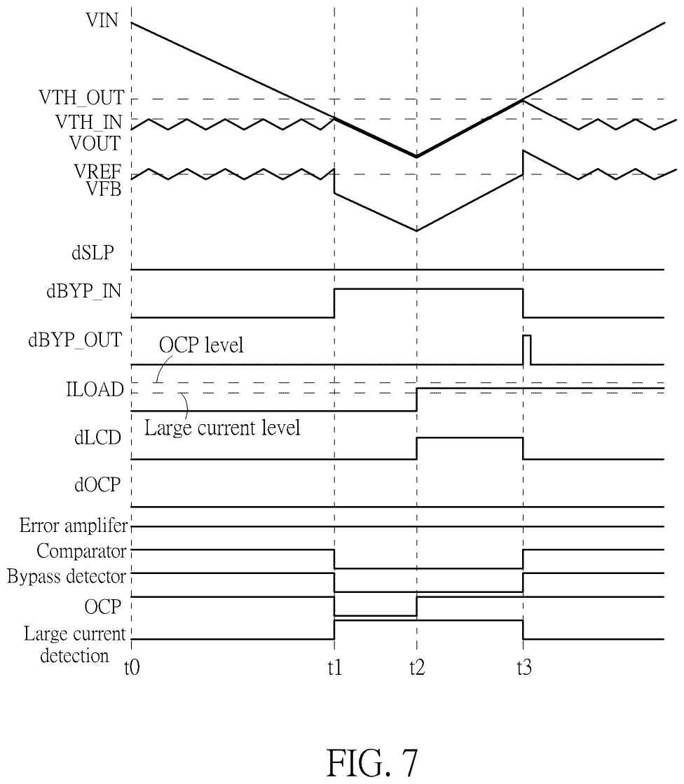

FIG. 7 is a timing diagram depicting the transition from bypass mode to back CCM mode with a large current event occurring in the buck converter 100. Between time t0 and t1, the buck converter 100 is operating in CCM mode. The input voltage VIN is higher than the output voltage VOUT but starts dropping. The feedback voltage VFB is oscillating around the reference voltage VREF, indicating normal regulation. The error amplifier 132, comparator 134, bypass detector 170, and over-current protection circuit 162 are all active. The large current detection circuit 164 is disabled.

At time t1, the input voltage VIN drops to reach a voltage threshold VTH_IN, which initiates the transition into bypass mode. The bypass mode signal dBYP_IN goes high, causing the buck converter 100 to enter into the bypass mode. The bypass detector 170, comparator 134 and over-current protection circuit 162 are disabled to reduce power consumption. The large current detection circuit 164 is enabled for its function.

Between time t1 and t2, the buck converter 100 operates in bypass mode. The output voltage VOUT closely follows input voltage VIN as both continue to drop. The feedback voltage VFB drops below the reference voltage VREF, as the hysteresis switch SHYS turns off causing a hysteresis effect. Also, precise voltage regulation is no longer maintained. The error amplifier 132 remains on to monitor the output voltage VOUT.

At time t2, the input voltage VIN reaches its lowest point and begins to rise again. A large current event occurs (load current ILOAD rises above the large current level) causing the large current detector 164 to trigger the large current signal dLCD, which activates the over-current protection circuit 162.

Between time t2 and t3, because the load current ILOAD has not reached the OCP level, the buck converter 100 remains in the bypass mode. The output voltage VOUT closely follows the input voltage VIN. The large current detection circuit 164 and over-current protection circuit 162 are active, indicating active monitoring during bypass mode.

At time t3, the output voltage VOUT rises to reach a voltage threshold VTH_OUT, which initiates the transition out of bypass mode. The error amplifier 132 generates a pulse signal dBYP_OUT, signaling the end of bypass mode. The bypass detector 170, comparator 134, and over-current protection circuit 162 are reactivated. The large current detection 164 is disabled. This reconfiguration prepares the buck converter 100 to resume CCM operation. Following time t3, the buck converter 100 fully returns to CCM operation.

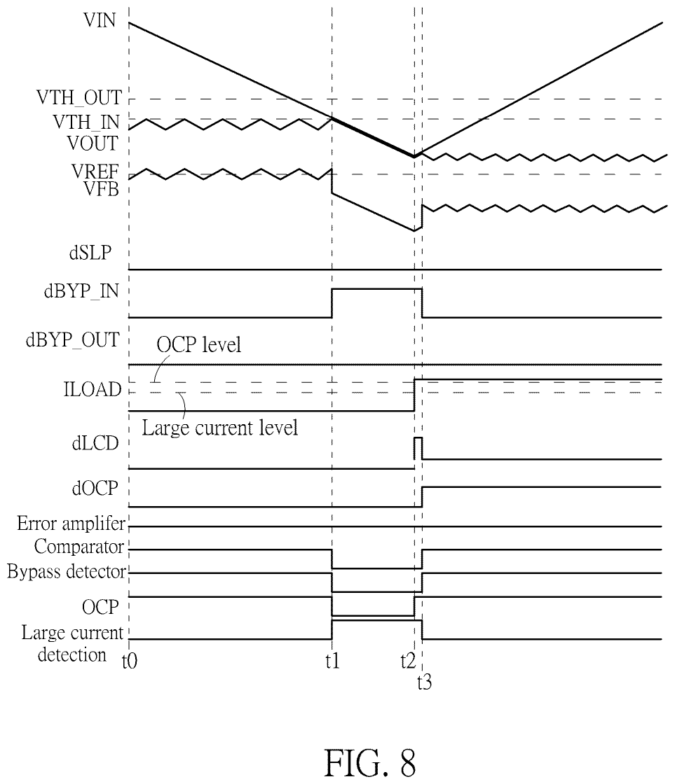

FIG. 8 is a timing diagram depicting the transition from bypass mode to back CCM mode with an over current event occurring in the buck converter 100. Between time t0 and t1, the buck converter 100 is operating in CCM mode. The input voltage VIN is higher than the output voltage VOUT but starts dropping. The feedback voltage VFB is oscillating around the reference voltage VREF, indicating normal regulation. The error amplifier 132, comparator 134, bypass detector 170, and over-current protection circuit 162 are all active. The large current detection circuit 164 is disabled.

At time t1, the input voltage VIN drops to reach a voltage threshold VTH_IN, which initiates the transition into bypass mode. The bypass mode signal dBYP_IN goes high, causing the buck converter 100 to enter into the bypass mode. The bypass detector 170, comparator 134 and over-current protection circuit 162 are disabled to reduce power consumption. The large current detection circuit 164 is enabled for its function.

Between time t1 and t2, the buck converter 100 operates in bypass mode. The output voltage VOUT closely follows input voltage VIN as both continue to drop. The feedback voltage VFB drops below the reference voltage VREF, as the hysteresis switch SHYS turns off causing a hysteresis effect. Also, precise voltage regulation is no longer maintained. The error amplifier 132 remains on to monitor the output voltage VOUT.

At time t2, the input voltage VIN reaches its lowest point and begins to rise again. An over current event occurs (load current ILOAD rises above the OCP level) causing the large current detector 164 to trigger the large current signal dLCD, which activates the over-current protection circuit 162.

After a brief interval, at time t3, the load current ILOAD surpasses the OCP threshold, triggering the over-current protection circuit 162. This event prompts the bypass detector 160 to deactivate the bypass mode signal dBYP_IN, initiating the buck converter 100 to transition back to normal mode. As part of this transition, the bypass detector 170, comparator 134, and over-current protection circuit 162 are all reactivated, while the large current detection 164 is simultaneously disabled. This reconfiguration prepares the buck converter 100 to resume CCM operation. Following time t3, the buck converter 100 fully returns to CCM operation. It's important to note that in this particular scenario, the pulse signal dBYP_OUT may not be generated. This is because the exit from bypass mode is triggered directly by the over-current protection mechanism, rather than through the standard bypass mode exit procedure.

The primary advantage of the buck converter design of the present disclosure lies in its ability to maintain extremely low quiescent current, particularly during bypass mode operation. By selectively disabling some components such as the on-time generator 180, comparator 134, and over-current protection circuit 162 during bypass mode, the buck converter 100 significantly reduces power consumption. This feature is especially valuable for extending battery life in portable devices, where standby power consumption is a critical factor. The ultra-low quiescent current performance sets this design apart from traditional buck converters, making it ideal for applications where every microamp of current savings matters.

Another key advantage is the ability of the buck converter to operate efficiently across a much wider range of input voltages than traditional designs. The advanced bypass mode implementation allows seamless transitions between continuous conduction mode (CCM), discontinuous conduction mode (DCM), sleep mode and bypass mode. This capability enables the converter to handle situations where the input voltage approaches or even falls below the desired output voltage, extending the useful life of batteries and improving overall system reliability in applications with varying power supply conditions. This wide input voltage range adaptability makes the converter particularly well-suited for battery-powered devices that need to operate efficiently as battery voltage declines over time.

The buck converter presented in this disclosure also incorporates sophisticated protection features that strike a balance between safety and power efficiency. The large current detection circuit provides a low-power method of monitoring for potential issues during bypass mode, while the ability to quickly re-enable full over-current protection when needed ensures robust protection against fault conditions. This adaptive approach maintains safety without compromising the ultra-low quiescent current performance. Furthermore, the design enables smooth transitions between different operating modes, minimizing output voltage fluctuations and ensuring stable power delivery to the load. The use of hysteresis in mode transitions prevents rapid switching between modes, further enhancing stability and efficiency.

By dynamically adjusting its operating mode based on input voltage and load conditions, the converter maintains high efficiency across a wide range of scenarios. This adaptability is particularly beneficial in applications with varying load demands, ensuring optimal power usage whether the device is in active use or standby mode. The combination of ultra-low quiescent current, wide input voltage range, and optimized efficiency directly translates to extended battery life in portable electronic devices. This can significantly improve the user experience and reduce the frequency of recharging or battery replacements, a crucial factor in the design of modern mobile and IoT devices.

Lastly, the ability of the buck converter to handle a wide range of input and output conditions can simplify overall system design. It reduces the need for additional voltage regulation stages or complex power management schemes, potentially lowering system cost and complexity. This simplification can lead to more compact designs, reduced component count, and improved reliability in end products. These advantages make this buck converter design particularly well-suited for modern battery-powered devices, IoT applications, and any system where power efficiency, adaptability, and long operating life are prime considerations. The invention represents a significant step forward in power management technology, addressing key challenges in the design of energy-efficient electronic systems and paving the way for the next generation of long-lasting, highly efficient portable devices.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

In the context of this disclosure, the terms “coupled,” “connected,” “connecting,” “electrically connected,” and similar expressions are used interchangeably to broadly denote the state of being electrically or electronically connected. Furthermore, an entity is deemed to be in “communication” with another entity (or entities) when it electrically transmits and/or receives information signals to/from the other entity, irrespective of whether these signals contain voice information or non-voice data/control information, and regardless of the signal type (analog or digital). It is important to note that this communication can occur through either wired or wireless means. The use of these terms is intended to encompass all forms of electrical or electronic connectivity relevant to the described embodiments.

The directional terms used in the embodiments such as up, down, left, right, upper-side, down-side, in front of or behind are just the directions referring to the attached figures. Thus, the direction terms used in the present disclosure are for illustration, and are not intended to limit the scope of the present disclosure. It should be noted that the elements which are specifically described or labeled may exist in various forms for those skilled in the art.

This interpretation of terminology is provided to ensure clarity and consistency throughout the specification and claims, and should not be construed as restricting the scope of the disclosed embodiments or the appended claims.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a graphics processing unit (GPU), a tensor processing unit (TPU), a neural network processing unit (NPU), a digital signal processor (DSP), an application specific integrated circuit (ASIC), a field programmable gate array (FPGA), other programmable logic devices (PLDs), discrete gate or transistor logic, discrete hardware components, any suitable combination thereof. Such hardware and apparatus shall be configured to perform the functions described herein.

A general-purpose processor may include, but is not limited to, a central processing unit (CPU), a microprocessor, or alternatively, any conventional processor, controller, microcontroller or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, RAM, ROM, EEPROM, CD-ROM or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A buck converter comprising:
a power stage comprising:
an input terminal for receiving an input voltage; and
an output terminal for outputting an output voltage;
a feedback network coupled to the power stage, configured to generate a feedback voltage according to the output voltage;
a control loop comprising:
an error amplifier (EA) configured to generate an EA voltage by comparing a reference voltage to the feedback voltage; and
a comparator (CMP) coupled to the error amplifier, configured to generate a CMP signal according to the EA voltage;
a logic circuit coupled to the control loop, configured to generate a logic control signal for implementing a control scheme according to a set of control signals;
a driver circuit coupled between the logic circuit and the power stage, configured to drive the power stage according to the logic control signal; and
a bypass detector configured to compare the input voltage with a predetermined threshold related to the output voltage and generate a bypass mode signal accordingly.

2. The buck converter of claim 1, further comprising:
an on-time generator coupled to the logic circuit, configured to generate a first control signal within the set of control signals; and
a zero current detector coupled to the logic circuit, configured to generate a second control signal within the set of control signals and a bypass enabling signal to the bypass detector.

3. The buck converter of claim 2, further comprising:
an over-current protection (OCP) circuit, configured to generate an over-current protection signal within the set of control signals; and
a large current detection circuit, configured to detect an output current.

4. The buck converter of claim 1, wherein the power stage further comprises:
a first switch and a second switch coupled in series forming a half bridge configuration between the input terminal and a ground;
an output inductor coupled between a switching node of the first switch and the second switch and the output terminal; and
an output capacitor coupled between the output terminal and the ground.

5. The buck converter of claim 4, wherein:
the first switch comprises:
a first terminal coupled to the input terminal;
a second terminal coupled to the switching node; and
a control terminal coupled to the driver circuit; and
the second switch comprises:
a first terminal coupled to the switching node;
a second terminal coupled to the ground; and
a control terminal coupled to the driver circuit.

6. The buck converter of claim 1, wherein the feedback network comprises:
a hysteresis switch coupled to the output terminal and controlled by the bypass mode signal;
a bypass resistor coupled to the output terminal;
a resistive divider coupled between the hysteresis switch and a ground; and
a feed forward capacitor coupled to the output terminal, the resistive divider and the error amplifier.

7. The buck converter of claim 1, wherein the control loop further comprises:
a resistor-capacitor (RC) circuit coupled between the error amplifier and a ground.

8. The buck converter of claim 7, wherein the error amplifier comprises:
a non-inverting terminal for receiving the reference voltage;
an inverting terminal coupled to the feedback network;
a first output terminal; and
a second output terminal coupled to the logic circuit.

9. The buck converter of claim 8, wherein the comparator comprises:
a non-inverting terminal coupled to the first output terminal of the error amplifier;
an inverting terminal;
a signal terminal coupled to the logic circuit; and
an output terminal coupled to the logic circuit.

10. The buck converter of claim 1, further comprising a load coupled between the output terminal and a ground.

11. A method of operating a buck converter, comprising:
operating the buck converter in a normal mode, wherein the normal mode comprises alternating activation of a high-side switch and a low-side switch to regulate an output voltage;
monitoring, by a zero current detector, a current through an output inductor of the buck converter;
generating, by the zero current detector, a bypass enabling signal;
enabling the bypass detector according to the bypass enabling signal;
comparing, by a bypass detector, an input voltage of the buck converter to a predetermined threshold related to the output voltage;
generating, by the bypass detector, a bypass mode signal when the input voltage falls below the predetermined threshold;
transitioning the buck converter from the normal mode to a bypass mode according to the bypass mode signal, wherein the bypass mode comprises the high-side switch being enabled and the low-side switch being disabled.

12. The method of claim 11, further comprising:
while operating in the bypass mode:
disabling the bypass detector and a comparator of the buck converter; and
monitoring, by an error amplifier of the buck converter, a difference between the feedback voltage and a reference voltage.

13. The method of claim 12, further comprising:
determining, by the error amplifier, whether the output voltage has risen above the reference voltage by a predetermined margin; and
if the output voltage has risen above below the reference voltage by the predetermined margin:
generating, by the error amplifier, a bypass out signal; and
enabling the comparator of the buck converter.

14. The method of claim 13, further comprising:
transitioning the buck converter from the bypass mode to the normal mode according to the bypass out signal.

15. The method of claim 11, further comprising:
while operating in the bypass mode:
disabling an over-current protection (OCP) circuit of the buck converter; and
enabling a large current detection circuit of the buck converter.

16. The method of claim 15, further comprising:
monitoring, by the large current detection circuit, a voltage difference between an input voltage and a switching node voltage of the buck converter.

17. The method of claim 16, further comprising:
determining, by the large current detection circuit, whether the voltage difference exceeds a predetermined threshold; and
if the voltage difference exceeds the predetermined threshold:
generating, by the large current detection circuit, a large current signal; and
enabling the over-current protection circuit.

18. The method of claim 17, further comprising:
comparing, by the over-current protection circuit, an output current with an over-current threshold; and
if the output current exceeds the over-current threshold, transitioning the buck converter from the bypass mode back to the normal mode.

19. The method of claim 18, further comprising:
if the output current does not exceed the over-current threshold, maintaining the buck converter in the bypass mode and disabling the over-current protection circuit.

20. The method of claim 11, further comprising:
operating the buck converter in a sleep mode before operating the buck converter in the normal mode, wherein the sleep mode comprises:
the high-side switch and the low-side switch being disabled; and
the bypass detector and a comparator of the buck converter being disabled.
